(19) United States
(12) Patent Application Publication
(10) Pub. No.: US 2007/0164655 A1
(43) Pub. Date: Jul. 19, 2007

(54) DISPLAY DEVICE

(76) Inventors: Tomoko KOZUKA, Hiratsuka-shi (JP); Hajime Tanaka, Hiratsuka-shi (JP); Akiyoshi Nakamura, Saitama-shi (JP); Akira Mikami, Hiratsuka-shi (JP); Takeo Ito, Kumagaya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/620,184

(22) Filed: Jan. 5, 2007

Related U.S. Application Data
(63) Continuation of application No. PCT/JP05/11529, filed on Jun. 23, 2005.

(30) Foreign Application Priority Data
Jul. 5, 2004 (JP) 2004-198254

(51) Int. Cl. H01J 63/04; H01J 1/62

(52) U.S. Cl. 313/495; 313/496; 313/497

(57) ABSTRACT

A display device comprises a fluorescent screen provided with a shading portion including a plurality of openings, and a fluorescent layer formed on the shading portion, and a metal-back layer provided on the fluorescent screen and including a plurality of dividing means and a plurality of divisions defined by the dividing means, wherein the dividing means are provided on the shading portion via the fluorescent layer interposed therebetween, and an electrical resistance between each pair of adjacent ones of the divisions located with a corresponding dividing means interposed between the each pair falls within a range of 10²Ω to 10⁵Ω via the fluorescent layer.

### CROSS-REFERENCE TO RELATED APPLICATIONS

This is a Continuation Application of PCT Application No. PCT/JP2005/011529, filed Jun. 23, 2005, which was published under PCT Article 21(2) in Japanese.

This application is based upon and claims the benefit of priority from prior Japanese Patent Application No. 2004-198254, filed Jul. 5, 2004, the entire contents of which are incorporated herein by reference.

### BACKGROUND OF THE INVENTION

1. Field of the Invention The present invention relates to a display device.

2. Description of the Related Art In recent years, flat-panel display devices, in which a large number of electron emission elements are opposed to a fluorescent screen, have been developed as display devices. Various electron emission elements now available fundamentally utilize field emission. For instance, a field emission display (hereinafter referred to as an “FED”) for emitting electron beams from its electron emission elements to cause a fluorescent member to emit light, and a surface-conduction electron-emitter display (hereinafter referred to as an “SED”) for emitting electron beams from its surface-conduction electron-emitter elements to cause a fluorescent member to emit light are known as flat-panel display devices.

For instance, in general, SEDs have a front substrate and rear substrate opposing each other with a predetermined gap therebetween, and the substrates, which have their peripheries bonded via a rectangular frame-shaped side wall interposed therebetween, provide a vacuum envelope. The interior of the vacuum envelope is highly evacuated to about 10⁻⁴ Pa or less. To withstand the atmospheric pressure on the front and rear substrates, a plurality of support members are provided between the substrates.

A fluorescent screen including fluorescent layers of red, blue and green is provided on the inner surface of the front substrate, and electron emission elements for exciting a fluorescent material to emit light are provided on the inner surface of the rear substrate. A large number of scanning lines and signal lines are arranged in a matrix and connected to the respective electron emission elements.

When an anode voltage is applied to the fluorescent screen, and electron beams emitted from the electron emission elements are accelerated by the anode voltage and collide with the fluorescent screen, the fluorescent screen emits light and displays an image. In SEDs constructed as above, the gap between the front and rear substrates can be set to several millimeters or less, which enables the display device to be made lighter and thinner than cathode ray tubes (CRTs) used as the displays of currently prevailing computers and TV sets.

To impart practical display characteristics to SEDs constructed as above, it is necessary to use the same fluorescent material as employed in cathode ray tubes and to use a fluorescent screen coated with an aluminum thin film called a metal back. In this case, it is desirable to set the anode voltage, applied to the fluorescent screen, to at least several kilo volts, and if possible, 10 kV or more.

However, in view of the resolution, the properties of the support members, etc., the gap between the front and rear substrates cannot be greatly enlarged, and need to be set to about 1 to 2 mm. Accordingly, in FEDs, a strong electric field will inevitably occur in the small gap between the front and rear substrates, thereby causing electrical discharge (dielectric breakdown) between the substrates.

When electrical discharge occurs, a current of 100 A or more may instantaneously flow, which may damage or degrade electron emission elements or fluorescent screen, and may even destroy driving circuits. Such damage and degradation will hereinafter be referred to as “damage due to electrical discharge.”0 Discharge that may cause failure is not allowable in products. To put SEDs into practical use, it is necessary to construct them so that they are prevented from damage due to discharge over a long period. However, it is very difficult to completely suppress discharge over a long period.

Therefore, it is very important to take measures to suppress the scale of discharge to a degree at which the effect of discharge upon, for example, electron emission elements can be ignored. A technique relevant to the idea is disclosed by, for example, Jpn. Pat. Appln. KOKAI Publication No. 2003-242911. In this technique, the metal back of an SED is divided into a plurality of portions. Specifically, the metal back is divided into the portions by a laser.

As described above, the metal back includes a plurality of divisions. When an SED having its metal back so constructed is used to display an image, discharge may occur between a certain division and the corresponding portion of the rear substrate. Moreover, in this case, discharge may occur even at a division adjacent to the discharging division. Thus, it is difficult to suppress enlargement of the scale of discharge.

### BRIEF SUMMARY OF THE INVENTION

The present invention has been made in light of the above. An object of the invention is to provide an excellent display quality display device in which enlargement of the scale of discharge is suppressed, and destruction/degradation of electron emission elements and fluorescent screen, and destruction of circuits are suppressed.

According to an embodiment of the invention, there is provided a display device comprising:

a fluorescent screen provided with a shading portion including a plurality of openings, and a fluorescent layer formed on the shading portion; and

a metal-back layer provided on the fluorescent screen and including a plurality of dividing means and a plurality of divisions defined by the dividing means, wherein the dividing means are provided on the shading portion via the fluorescent layer interposed therebetween, and an electrical resistance between each pair of adjacent ones of the divisions located with a corresponding dividing means interposed between said each pair falls within a range of 10²Ω to 10⁵Ω via the fluorescent layer.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view illustrating an SED according to an embodiment of the invention;

FIG. 2 is a sectional view of the SED, taken along line II-II of FIG. 1;

FIG. 3 is a plan view illustrating the fluorescent screen and metal-back layer of a front substrate incorporated in the SED;

FIG. 4 is a sectional view of the front substrate, taken along line IV-IV of FIG. 3;

FIG. 5 is a view illustrating the discharge suppression effect and withstand voltage characteristic between divisions in relation to the electrical resistance between the divisions and the width of the spaces between the divisions are varied;

FIG. 6 is a sectional view illustrating a modification of the front substrate shown in FIG. 4; and

FIG. 7 is a sectional view illustrating another modification of the front substrate shown in FIG. 4.

### DETAILED DESCRIPTION OF THE INVENTION

An embodiment, in which the display device of the invention is applied to an SED, will be described in detail with reference to the accompanying drawings.

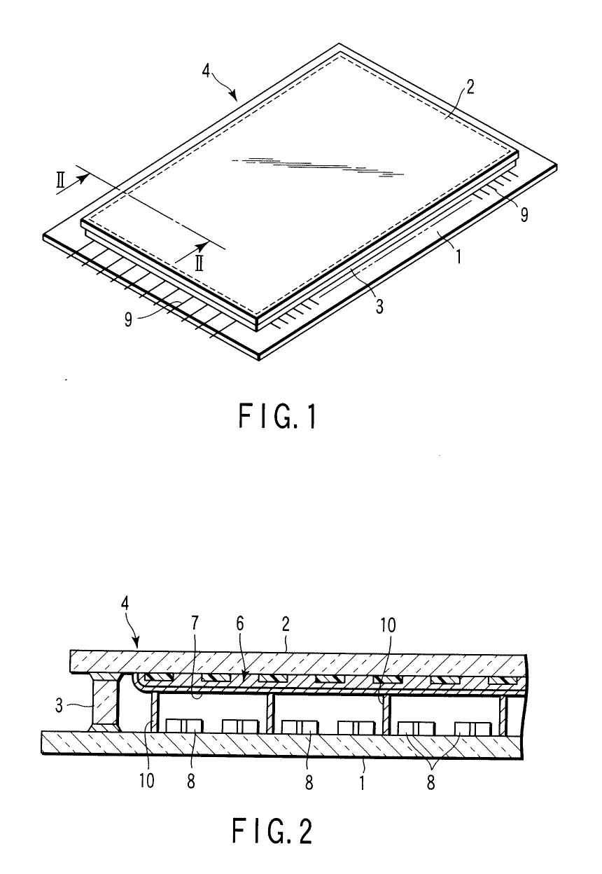

As shown in FIGS. 1 and 2, the SED comprises a front substrate 2 and rear substrate 1 formed of rectangular glass members. The front and rear substrates 2 and 1 are arranged opposite to each other with a gap of 1 to 2 mm therebetween. The front and rear substrates 2 and 1 have their peripheries bonded to each other via a rectangular frame-shaped side wall 3, thereby forming a flat, rectangular vacuum envelope 4 having its interior highly evacuated to about 10⁻⁴ Pa or less.

A fluorescent screen 6 is provided on the inner surface of the front substrate 2. The fluorescent screen 6 is formed of fluorescent layers that emit red, green and blue beams, and a shading layer. A metal-back layer 7 serving as an anode electrode is formed on the fluorescent screen 6. During a display operation, a predetermined anode voltage is applied to the metal-back layer 7.

A large number of electron emission elements 8 that emit electron beams for exciting the fluorescent screen 6 are provided on the inner surface of the rear substrate 1. The electron emission elements 8 correspond to pixels and are arranged in rows and columns. The electron emission elements 8 are driven by matrix lines 9.

Further, a large number of plate-like or columnar spacers 10 are interposed between the rear and front substrates 1 and 2 to withstand the atmospheric pressure.

The anode voltage is applied to the fluorescent screen 6 via the metal-back layer 7, and electron beams emitted form the electron emission elements 8 are accelerated by the anode voltage and collide with the fluorescent screen 6. As a result, the corresponding fluorescent layers emit light to display an image.

The above-mentioned fluorescent screen 6 and metal-back layer 7 will now be described in detail.

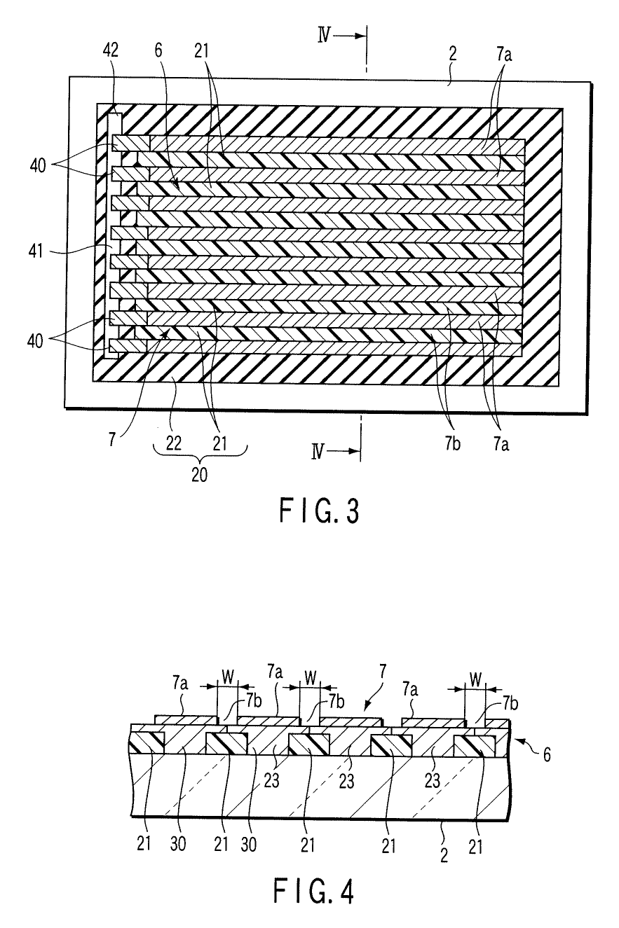

As shown in FIGS. 3 and 4, the fluorescent screen 6 provided on the inner surface of the front substrate 2 has a shading portion 20. The shading portion 20 includes, for example, a large number of stripes 21 arranged parallel to each other with predetermined gaps therebetween, and a rectangular frame 22 extending along the periphery of the fluorescent screen 6. The shading portion 20 also includes a plurality of openings 23 formed between pairs of adjacent ones of the stripes 21. A large number of fluorescent layers 30 that emit red (R), green (G) and blue (B) beams are provided adjacent to each other on the shading portion 20 and in the openings 23. In the embodiment, each fluorescent layer 30 contains a transparent conductive material.

The metal-back layer 7 provided on the fluorescent screen 6 includes a plurality of divisions 7a and a plurality of dividing portions 7b. The divisions 7a are divided by the dividing portions 7b. More specifically, the divisions 7a of the metal-back layer 7 are formed as thin stripes, and extend parallel to each other mainly at locations corresponding to the openings 23, with predetermined gaps interposed between pairs of adjacent ones of the divisions.

The dividing portions 7b are formed in stripes and located between pairs of adjacent ones of the divisions 7a. The dividing portions 7b are provided on the stripes 21 of the shading portion 20 via the fluorescent layers interposed therebetween. It is desirable that the dividing portions 7b do not extend to the regions opposing the openings 23. To set margins, it is preferable to make each division 7a overlap with the corresponding stripe 23. In the embodiment, to divide the metal-back layer 7 into the divisions 7a, the dividing portions 7b are formed by removing parts of the metal-back layer 7.

When the metal-back layer 7 is divided by the dividing portions 7b, it is difficult to apply a predetermined voltage to the entire metal-back layer. Therefore, the divisions 7a are connected to a common electrode 41 via resistors 40. A high-voltage supply 42 is formed at part of the common electrode 41, and enables a high voltage to be applied thereto by appropriate means. As a result, the voltage can be applied to the entire metal-back layer, with a discharge-current suppressing function secured.

The inventors of the present application have caused an image to be displayed while changing the electrical resistance between pairs of adjacent ones of the divisions 7a arranged with the dividing portions 7b interposed, and also changing the width of the dividing portions (i.e., the width between each pair of adjacent divisions 7a), thereby estimating the discharge suppression effect and the withstand voltage characteristic between the pairs of the divisions. Specifically, estimation was performed with the electrical resistance between the divisions 7a set to 10Ω, 10²Ω, 10⁵Ω, 10⁶Ω and an overload (O.L.) via the fluorescent layer 30, and with the width W set to 50 μm and 100 μm. The overload means a value that cannot be measured by a resistance meter. In the embodiment, the overload means 10⁷Ω or more. The electrical resistance is set by adjusting, for example, the ratio of a conductive material in the fluorescent layer 30.

For the estimation of the discharge suppression effect, the case where enlargement of the scale of discharge is suppressed and no problem occurs practically was indicated by mark ∘, and the case where the scale of discharge is enlarged and a problem occurs practically was indicated by mark X . Similarly, for the estimation of the withstand voltage between the divisions 7a, the case where the withstand voltage characteristic is good and no problem occurs practically was indicated by mark ∘, and the case where the withstand voltage characteristic is not good and a problem occurs practically was indicated by mark X.

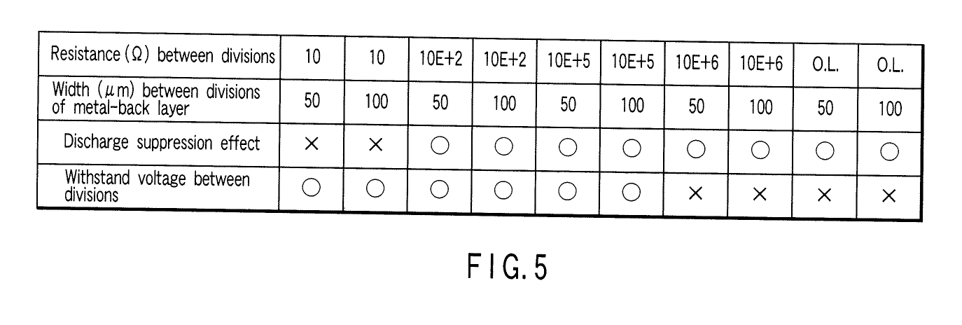

As seen from FIG. 5, concerning the discharge suppression effect, when the electrical resistance is set to 10²Ω, 10⁵Ω or 10⁶Ω, it is determined that no problem occurs practically. From this, it is understood that 10²Ω is the lower limit for suppressing discharge between the divisions 7a. Concerning the withstand voltage between the divisions 7a, when the electrical resistance is set to 10Ω, 10²Ω or 10⁵Ω, it is determined that no problem occurs practically. Namely, if the electrical resistance is set to 10⁶Ω, the resultant withstand voltage is too high, therefore little current flows between the divisions 7a. Accordingly, if discharge occurs between a certain division 7a and the corresponding electron emission element, and the charge exceeding the capacity of the division 7a is accumulated therein, discharge also occurs between the discharging division and another division adjacent thereto. In contrast, when the electrical resistance is set to 10⁵Ω, the resultant withstand voltage is not so high, therefore a little current flows between the divisions 7a. Accordingly, even if discharge occurs at a certain division 7a, a little current continues to flow from the discharging division to the division adjacent to it. This prevents secondary electrical discharge between the discharging division to the division adjacent to it, thereby suppressing enlargement of the scale of discharge.

From the above, it is understood to be desirable to set, within the range of 10²Ω to 10⁵Ω via the fluorescent layer 30, the electrical resistance between each pair of adjacent ones of the divisions 7a provided with the dividing portions 7b interposed therebetween. Therefore, in the above-described SED of the embodiment, the electrical resistance between the divisions 7a provided with the dividing portions 7b interposed therebetween is set within the range of 10²Ω to 10⁵Ω via the fluorescent layer 30.

In the SED constructed as the above, the electrical resistance between the divisions 7a provided with the dividing portions 7b interposed therebetween is set within the range of 10²Ω to 10⁵Ω via the fluorescent layer 30. The electrical resistance can be set by adjusting, for example, the ratio of a conductive material in the fluorescent layer 30.

Accordingly, even if electrical discharge occurs in a certain division 7a, enlargement of its scale can be suppressed, thereby suppressing destruction/degradation of the electron emission elements and fluorescent screen, and destruction of circuits. As a result, an excellent display quality SED can be acquired.

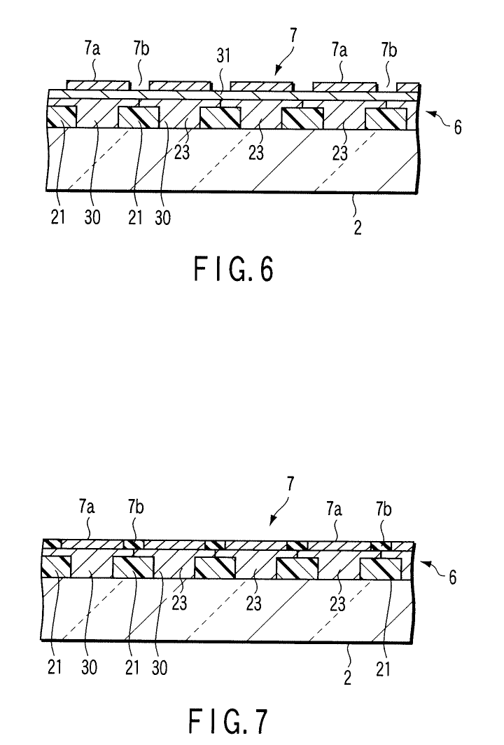

The invention is not limited to the above-described embodiment, but may be modified in various ways without departing from the scope. For instance, in the front substrate 2, a conductive film 31 formed of a transparent conductive material, such as ITO, may be formed on the fluorescent layer 30, and the metal-back layer 7 be formed on the conductive film, as shown in FIG. 6. In this case, no conductive material may be contained in the fluorescent layer 30. Accordingly, the electrical resistance between the divisions 7a provided with the dividing portions 7b interposed therebetween is set in accordance with, for example, the thickness of the conductive film 31. It is sufficient if the conductive film 31 opposes at least the stripes 21 of the shading portion 20 and is interposed between the fluorescent layer 30 and metal-back layer 7.

As shown in FIG. 7, the dividing portions 7b may be formed by oxidizing (anodic oxidation) parts of the metal-back layer 7. In this case, divisions 7a as conductive portions and dividing portions 7b of a high electrical resistance can be acquired.

The invention is not limited to SEDs, but is also applicable to FEDs as display devices.

What is claimed is:

1. A display device comprising:
a fluorescent screen provided with a shading portion including a plurality of openings, and a fluorescent layer formed on the shading portion; and
a metal-back layer provided on the fluorescent screen and including a plurality of dividing means and a plurality of divisions defined by the dividing means,
wherein the dividing means are provided on the shading portion via the fluorescent layer interposed therebetween, and an electrical resistance between each pair of adjacent ones of the divisions located with a corresponding dividing means interposed between said each pair falls within a range of 10²Ω to 10⁵Ω via the fluorescent layer.

2. The display device according to claim 1, wherein the fluorescent layer contains a conductive material.

3. The display device according to claim 1, further comprising a conductive film provided between the fluorescent layer and the metal-back layer and opposing the shading portion.
